(19) United States
(12) Patent Application Publication
(10) Pub. No.: US 2013/0086133 A1
(43) Pub. Date: Apr. 4, 2013

(54) METHOD AND APPARATUS FOR FILE REVISION TRACKING

(71) Applicants: Blaine Madison Mucklow, Smyrna, GA (US); Ramon Juan San Andres, Duluth, GA (US)

(72) Inventors: Blaine Madison Mucklow, Smyrna, GA (US); Ramon Juan San Andres, Duluth, GA (US)

(73) Assignee: General Electric Company, Schenectady, NY (US)

(21) Appl. No.: 13/248,759

(22) Filed: Sep. 29, 2011

(51) Int. Cl. G06F 17/30

(52) U.S. Cl. 707/821; 707/E17.005

(57) ABSTRACT

A method and apparatus for tracking revisions to a set of files that collectively represent a large structure, such as a geospatial network. A file revision tracker program is employed to process and store copies of revised files into a version control system (VCS). Database records are created to represent each revised file as a revision to a VCS controlled file. The database records can be queried, sorted and linked to each other to identify and associate one or more revisions of VCS controlled files with each modification to the large structure, such as a geospatial network, over time.

### BACKGROUND OF THE INVENTION

The subject matter disclosed herein relates to file revision tracking in a version control system.

A version control system (VCS) is typically employed for efficient storage and access to revisions of each of one or more version controlled files. A version control system is often employed within a software development environment to store revisions to files including computer programming source code. A version control system may be employed to store files including other types of information, but typically does not track relationships between revisions (revised copies) of different version controlled files. In some circumstances, additional functionality beyond what a version control system typically provides, is required and/or beneficial to the operation of systems and applications.

The discussion above is merely provided for general background information and is not intended to be used as an aid in determining the scope of the claimed subject matter.

### BRIEF DESCRIPTION OF THE INVENTION

An apparatus, system and method is disclosed for tracking revisions to a set of files that collectively represent a large structure, such as a geospatial network. A file revision tracker program is employed to process and store copies of revised files into a version control system (VCS). Database records are created to each represent a revised copy of a file as a revision to a VCS controlled file. The database records can be queried, sorted and linked to each other to identify and associate one or more revisions of VCS controlled files with each modification to the large structure, such as a geospatial network or a power distribution network, for example, over time.

An advantage that may be realized in the practice of some of the disclosed embodiments is that evolution, expressed in the form of modifications to a large structure over time, is better represented and understood via the relational querying, sorting and linking capabilities that are present within a database, but absent from a typical version control system.

In one exemplary embodiment, there is disclosed an apparatus for tracking revisions to each of a set of files, including a version control system that is configured to store one or more versions of each of a set of files, a database, and a revision tracker for facilitating interoperation between the version control system and the database.

In another exemplary embodiment, a method for tracking revisions to a set of files is disclosed, the method comprising the steps of creating a revised file relative to a file stored within a version control system, storing the revised file into the version control system, obtaining storing information from the version control system that is associated with the storing of the revised file, and storing database information into a database record that includes at least a portion of the storing information.

In another exemplary embodiment, a system for tracking revisions to each of a set of files is disclosed, including a version control system that is configured to store one or more versions of each of a set of files, a database, a revision tracker for facilitating interoperation between the version control system and the database.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a diagram illustrating a representation of a network that is delineated into separate portions;

FIG. 2 is a diagram illustrating a set of files that each represent a portion of the network of FIG. 1 and that can be each revised over time;

FIG. 3 is a diagram illustrating an embodiment of a database record storing information associated with a file revision; and

FIG. 4 is a diagram illustrating operation of a file revision tracker software application.

### DETAILED DESCRIPTION OF THE INVENTION

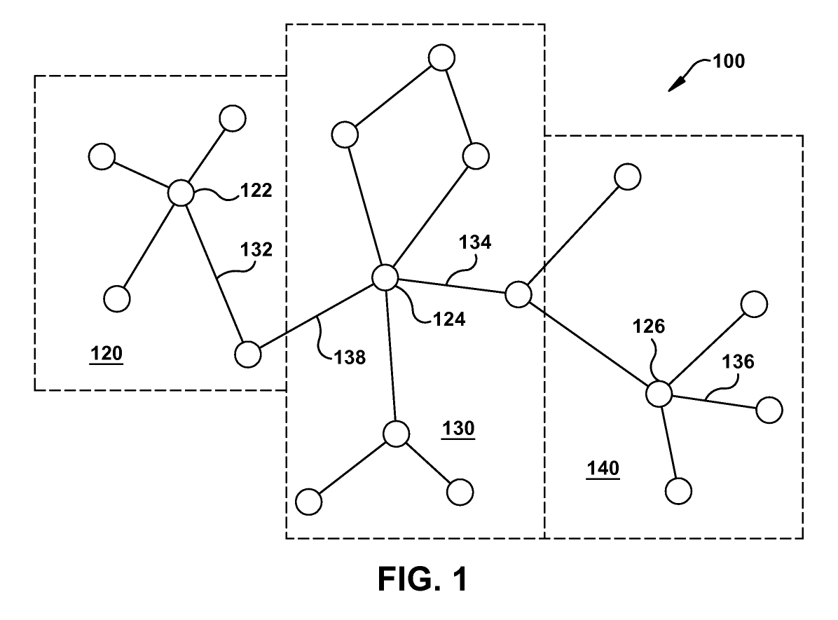

FIG. 1 is a diagram illustrating a representation of a network 100 that is delineated into separate portions 120, 130 and 140. As shown, a network 100 includes an arrangement of nodes and arcs, including for example, nodes 122-126 and including for example, arcs 132-136. In some embodiments, the network 100 represents a large structure, such as a power distribution system or power distribution network. Such a power distribution network, also referred to herein as a power distribution system, can be classified as a type of geospatial information system.

As a power distribution network, each node 122-126 represents a type of power distribution component having a particular set of attributes, such as for example, a switch or transformer of a particular type and having a particular rating and/or capacity during operation. As a power distribution system, each arc 132-136 represents an electrical power transmission line segment, having a particular set of attributes, such as type, length, capacity, etc.

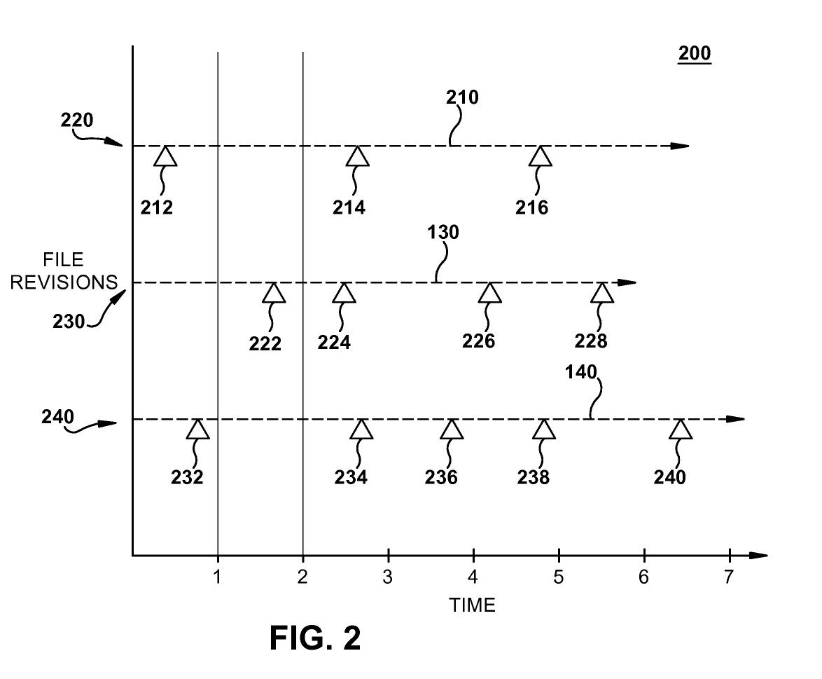

FIG. 2 is a diagram 200 illustrating a set of files 220, 230 and 240 that each represent a respective portion 120, 130 and 140 of the network 100 of FIG. 1 and that are each subject to revision over time in response to modification(s) to the network 100. The network 100 is represented as a set of data that is collectively stored into separate files 220, 230 and 240. Each file includes data representing a separate portion of the network 100. As shown, file 220 represents network portion 120 and includes five (5) entire nodes and four (4) entire arcs and one (1) partial arc 138. File 230 includes eight (8) entire nodes and eight (8) entire arcs and three (3) partial arcs. File 240 includes five (5) entire nodes and three (3) entire arcs and two (2) partial arcs.

As the network evolves and is modified over time, nodes and/or arcs can be added or deleted from the network 100. A correct representation of a modification to the network, also referred herein as a network modification or revision to the network 100, requires a revision to each file 220, 230 and 240 that represents at least a portion of the network 100 that is being revised.

As shown in FIG. 2, file 220 is revised at three (3) points in time 212-216, in order to timely represent revisions to a respective portion 120 of the network 100, that is represented by file 220. Also, file 230 is revised at four (4) points in time 222-228, in order to timely represent revisions to a respective portion 130 of the network 100, that is represented by file 230. File 240 is revised at five (5) points in time 232-240, in order to timely represent revisions to a respective portion 130 of the network 100, that is represented by file 140.

A modification to the network 100 may require revisions to multiple files 220, 230 and 240. For example, revision 212 of file 220 and revision 232 of file 240 collectively represent a first modification to the network 100 performed at a first point in time. Revision 222 represents a second modification to the network 100 performed at a second point in time. Revisions 214, 224 and 234 collectively represent a third modification to the network 100 performed at a third point in time.

A version control system (VCS) is typically employed for storage and access of revised copies of each of one or more version tracked files. Tracking revisions to the network 100 as a whole can be facilitated by tracking relationships between the revised copies of different files that collectively represent a particular modification to the network 100 performed at a particular time. A version control system does not typically track relationships between a plurality of revised copies of different files having some other defined association with each other.

According to an embodiment of the invention, a database is employed for tracking relationships between a set of revised copies of different files. In the context of representing a network, the set of revised copies of different files collectively represent one (1) particular modification to the network 100. These revised copies are associated with each other and are members of a file revision set, that is itself, associated with one (1) particular modification to the network 100. Tracking such relationships between revised copies of different files facilitates tracking multiple and different modifications to the network 100 over time.

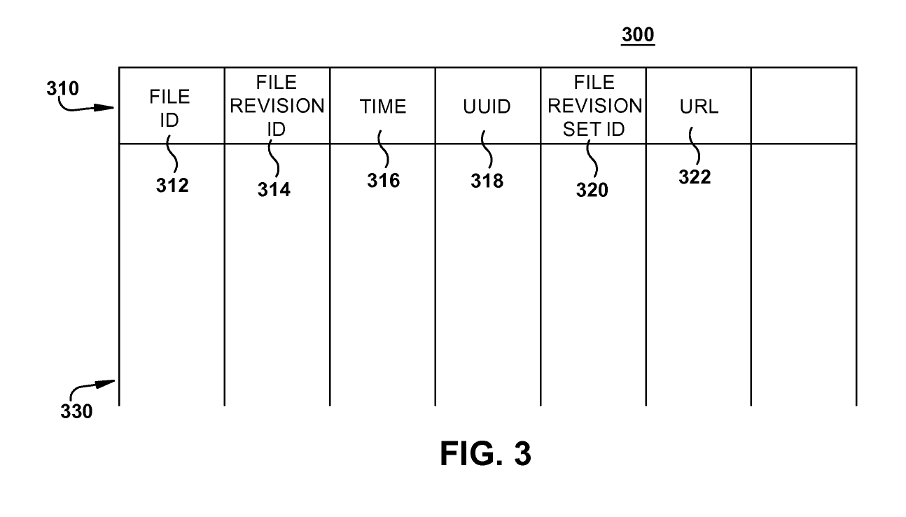

FIG. 3 is a diagram 300 illustrating an embodiment of a database record 310 storing information associated with a file revision. Each database record 310 includes a set of fields 312-322. As shown, a first field stores a file identifier 312. A second field stores a file revision identifier 314 which identifies a revision to the file referenced by the file identifier 312. A third field stores a timestamp 316, which represents a date and time of the file revision associated with the file revision identifier 312. In some embodiments, the file revision, also referred to as a version of a file, is represented by a combination of a major revision number and a minor revision number, such as for example, “version 2.3”.

A fourth field stores a universally unique identifier (QUID) 318 which uniquely identifies the particular file revision of the particular file represented by this database record 310. A fifth field stores a file revision set identifier 320 which is an identifier of a set of one or more revised files (file revisions) associated with a modification to the network 100. This set of file revisions collectively represent the modification to the network 100, which may include modifications to multiple nodes, arcs and files that include and represent these nodes and arcs. This network modification defines a relationship between a plurality of file revisions associated with the network modification, that a VCS would typically not be designed to track.

There can be many database records 310 that each include the same file revision set identifier 320 to indicate that each database record 310 respectively represents one member of this set of file revisions representing the particular modification to the network 100. A sixth field stores a uniform resource locator (URL) 322 which represents a network-accessible location of a copy of a file revision of the file identified by the file identifier 312.

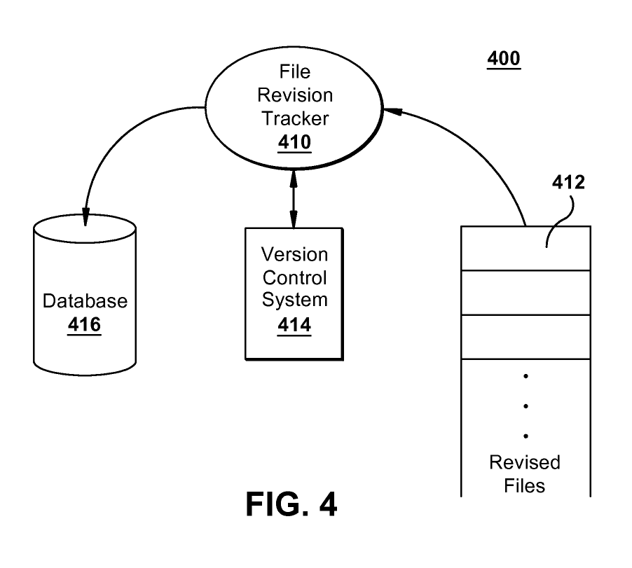

For a particular network, there can be numerous revisions to each of hundreds of files that collectively represent modifications to the network 100 over time. The database provides for querying, sorting and selection of file revisions for which to track and understand the evolution of the network 100. A typical data base query retrieves one or more database records 310 that satisfy the parameters of a particular database query. These database records can be listed in a database table 330, like the one database record 310 shown in the diagram 300 of FIG. 3, where each row of the database table 330 represents a particular database record 310 which is identified by and satisfies the parameters of the database query, and where each column of the table 330 represents a field 312-322 of each database record 310 residing within the database table 330. FIG. 4 is a diagram 400 illustrating operation of a file revision tracker software application 410, also referred to as a file revision tracker program 410. As shown, a file revision tracker program (FRTP) 410 processes each revised copy of a file placed into a queue 412. Each revised copy of a file is also referred to herein as a revised file or file revision of a VCS controlled file.

In some embodiments, the queue 412 is a directory in which revised files are placed into prior to processing by the FRTP 410. The FRTP 410 reads each revised file in order of time of placement within the queue 412 and if appropriate, inputs each revised file into a version control system (VCS) 414. To be appropriate, the FRTP 410 verifies that the revised file corresponds to a version controlled file stored within the VCS 414, and stores the revised file into the VCS 414 as a revision of the version controlled file. The version controlled file has an associated file identifier 312, such as for example, a unique file name. The revised file is assigned file revision identifier 314, such as a major and minor revision number. The file revision associated with the file revision identifier 314 is assigned timestamp 316, which includes date and time information.

The action of storing the revised file into the VCS 414 is referred to as a check in or commit procedure. Performance of the check in procedure causes the VCS 414 to output check in (commit) associated information that is also referred to herein as VCS storing information. In some embodiments, the VCS storing information includes one or more of a file identifier 312, file revision identifier 314, and timestamp 316. For each check in of a revised file, the FRTP 410 creates a database record 310 within a database 416 and stores the file identifier 312, the file revision identifier 314, and the timestamp 316 into the respective fields 312-316 of the database record 310.

The FRTP 410 further generates a universally unique identifier (UUID) 318 in association with the database record 310 and stores it into the field 318 of the database record 310. The universally unique identifier (UUID) 318 is also stored into a revision log message associated with the VCS 414. The storage of the UUID 318 within both the database 416 and the VCS 414 is employed as a cross-referencing mechanism between the VCS 414 and the database 416.

In this manner, a database record 310 associated with the UUID 318 can be referenced and addressed from the VCS 414 via the VCS log message and the VCS log message can be referenced and addressed from the database record 310 via the same UUID. In other embodiments, the UUID 318 can be stored in association with the VCS 414 outside of a VCS log message. In some embodiments, the UUID 318 can be stored into any memory, such as a log, record or file, that is associated with the version control system 414. The memory, record or file should reference and/or be associated with at least one prior action, such as one or more file revisions (file versions), that are being managed within the VCS 414.

A file revision set identifier 320 is also generated and stored into the field 320 of the database record 310. The same value of the file revision set identifier 320 is stored into every member of a set of database records 310 that are each associated with a same modification to the network 100.

The file revision set identifier is determined and managed by the file revision tracker program 410. In some embodiments, a queue 412 functions as a work space within which a set of revised files are placed at one time for processing by the file revision tracker program 410. When processing, the file revision tracker program assigns a unique file revision set identifier 320 to each revised file of the set. Each database record 310 that is associated with each file of the set is assigned the same file revision set identifier 320.

A uniform resource locator (URL) 322 is also generated and stored into the field 322 of the database record 310. In some embodiments, the VCS 414 itself establishes each file revision (revised file) to be accessible via a URL.

The uniform resource locator (URL) provides an address for network access, and which in some embodiments may include Internet access, for which to access the revised file within the version control system 414. While stored into the VCS 414, the revised file is stored as a version of a VCS controlled file that is identified by file identifier 312 and the file revision identifier 314, and associated with the timestamp 316 that are stored within the database record 310.

The database records 310 are each created to represent each revised file as a revision to a VCS controlled file. In some circumstances, there may be hundreds of VCS controlled files. Each of these files can have many revisions and versions that are created and stored into the VCS 414 over time. The database records corresponding to these file revisions, as a group, can be queried, sorted and linked to each other to identify and associate one or more revisions of VCS controlled files with each modification to the large structure, such as a geospatial network, over time.

In some embodiments, a checksum value that is calculated via performance of a checksum algorithm procedure is computed for each file revision (version) that is stored inside of the VCS 414. This checksum value can also be stored inside of the corresponding database record 310 that is associated with the file revision.

In some embodiments, software is designed and periodically executed to verify consistent cross-referencing between each file revision and each corresponding integrity check of the information content of the database record 310. This is also referred to herein as a background integrity check procedure.

In some embodiments, this program executes a query into a relational database 416 to generate a sorted table of database records 310, reads each database record 310 and checks out a copy of a file revision from the VCS 414 in accordance with the information (metadata) stored within the database record 310, and verifies that the file revision copy exists, and that it has correct and consistent associated meta data, including that it has a correct and consistent checksum value, file identifier 312, file revision identifier 314, timestamp 316, UUID 318 and/or file revision set identifier 320 relative to its corresponding and associated database record 310. Execution of the above integrity check procedure can be itself time stamped within the corresponding database record 310 and/or within the VCS 414 itself. In this type of embodiment, if a database record 310 and an associated file revision pass an integrity check, then a “last-checked” timestamp value can be updated within the corresponding database record 310 and within the VCS 414 itself.

As described above, a version control system provides an efficient means for storing revisions of one or more large files over time. Such version control functionality is not typically provided by a database 416. A database, unlike a version control system 414, provides a means for querying, sorting and linking a plurality of revisions to each of a plurality of files over time, that have some defined or identifiable relation to each other. Such database functionality is typically not provided by a version control system 414.

Embodiments of the invention can provide benefits of both a version control system and of a database in one apparatus. The software of the FRTP 410 has the technical effect of facilitating inter-operation between a VCS 414 and a database 416 for tracking defined relationships between various versions of revised files that represent some larger structure, such as a geospatial network or power distribution network, for example.

In some embodiments, the system of the invention spans over a wide area. For example, in some use embodiments, the FRTP 410 accesses the database 416 and/or the VCS 414 over a network that can span across state and/or national boundaries via a network or interconnection of multiple networks, such as the Internet. In other embodiments, the FRTP 410 accesses the database 416 and/or the VCS 414 locally via a direct communications link and/or over a local area network.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-9. (canceled)

10. A method for tracking revisions to a set of files, comprising the steps of:
creating a revised file relative to a file stored within a version control system;
storing the revised file into a version control system;
obtaining a file revision identifier received from the version control system that is associated with the step of storing of the revised file;
storing database information into a database record that comprises at least the obtained file revision identifier;
generating a universally unique identifier (UUID) in association with the database record;
storing the generated UUID in the database record; and
storing the generated UUID into a revision log message associated with the version control system.

11. The method of claim 10 wherein the database information comprises a file identifier.

12. The method of claim 10 wherein the database information comprises a file revision identifier.

13. The method of claim 10 wherein the database information comprises a timestamp.

14. (canceled)

15. The method of claim 10 wherein the database information comprises a file revision set identifier.

16. The method of claim 10 wherein the database information comprises a uniform resource locator.

17-20. (canceled)
